(19) United States
(12) Patent Application Publication
(10) Pub. No.: US 2004/0088536 A1
(43) Pub. Date: May 6, 2004

(54) Method and apparatus for providing trusted channel among secure operating systems adopting mandatory access control policy

(76) Inventors: Jae Deok Lim, Daejeon (KR); Joon Suk Yu, Daejeon (KR); Sung Kyong Un, Daejeon (KR); So-Young Doo, Daejeon (KR); Jeong Nyeo Kim, Daejeon (KR); Sung Won Sohn, Daejeon (KR)

Correspondence Address: JACOBSON HOLMAN PLLC, 400 SEVENTH STREET N.W., SUITE 600, WASHINGTON, DC, 20004, US

(21) Appl. No.: 10/693,882

(22) Filed: Oct. 28, 2003

(30) Foreign Application Priority Data
Oct. 29, 2002 (KR) 10-2002-0066130

(51) Int. Cl. H04L 9/00

(52) U.S. Cl. 713/151

(57) ABSTRACT

An apparatus for providing a trusted channel among secure operating systems (OSs) to which a mandatory access control (MAC) policy is applied includes on a data transmission side a trusted channel sub system, a MAC module and a kernel memory. The apparatus further includes on a data reception side a trusted channel system and a kernel memory. By using the apparatus, the contents of data can be prevented from being exposed even in case the packet is intercepted while being transmitted since the packet is encrypted. Furthermore, even though the contents of the data packet are replaced with malicious contents, such modulation of data can be detected by examining the integrity of the packet through the use of authentication data.

### FIELD OF THE INVENTION

The present invention relates to a method and an apparatus for providing a trusted channel among secure operating systems (OSs) employing a mandatory access control (MAC) policy; and, more particularly, to a method and an apparatus for providing a trusted channel capable of automatically encrypting a packet to be transmitted through a network without a manipulation of a user by using a security class of the MAC; decrypting a received encrypted packet; and authenticating the packet.

### BACKGROUND OF THE INVENTION

In general, rapid development of Internet and Network technologies has increased personal network services such as an e-commerce and an Internet banking as well as Intranet services for an enterprise such as a groupware and an electronic approval system.

As a result, transmission of security data of an enterprise and an individual and, more particularly, financial security data (e.g., credit card number, password, personal information) has also been rapidly increased. However, as hacking technologies for network packets such as a sniffing and spoofing are being rapidly developed and the number of hacking is on the rise, the risk that the security data within network traffics are exposed by such hacking programs is also increased.

Therefore, there have been provided many solutions for defending against the increased risk of data exposure, such as an SHTTP (Secure Hypertext Transfer Protocol) and an SSL (Secure Socket Layer). However, since the use of these solutions are limited to several specific services, it is difficult to use these solutions for the protection of the entire network. Furthermore, since these solutions are provided at users' level, safe transmission of data may not be ensured in case the system is instable because of hacking or instable setting, in which case extra works, e.g., installation of an extra program and environment setting, are required.

As another method for obtaining data security in network communications, IPSec (IP Security) technology is widely employed. The IPSec technology provides security at an Internet protocol (IP) level and it is mainly used to provide security to a network such as a virtual private network (VPN). Techniques employed to implement the IPSec are standardized as IETF (Internet Engineering Task Force) RFC (Request For Comments) documents.

Widely used among such techniques for the implementation of the IPSec is an IPSec security protocol which includes an authentication header (AH) and an encapsulating security payload (ESP). It is the ESP that provides encryption of data for confidentiality thereof.

Both of the AH and the ESP should support a security associations (SA) concept meaning a simplex (one-way) connection providing a security service to network traffic in order to implement the IPSec.

Further, packet protection offered by the IPSec is determined based on a security policy database (SPD), which is set and maintained by a user, a system manager or an application. Packets select one of three processing modes based on an IP or transport layer header information in accord with the SPD. The three processing modes are as follows: apply, bypass and discard. Since the IPSec is standardized, it can be applied to general systems to maintain network security by setting various policies through the use of diversified encryption and authentication algorithms.

However, the IPSec has many drawbacks. Since the IPSec has a very complicated architecture and, further, environment setting therefor is very difficult, security provided by the IPSec may be reduced in case the system manager does not thoroughly conducts the environment setting and policy managements. Furthermore, since the IPSec does not have a function for transmitting access control information of a user who accesses remotely thereto in an OS to which a control access policy such as MAC is applied, a method for providing a new. channel for transferring the access control information is required.

### SUMMARY OF THE INVENTION

It is, therefore, an object of the present invention to provide a method and an apparatus for providing a trusted channel among security operating systems (OSs) adopting a mandatory access control (MAC) policy. The present invention is capable of providing a new header by using a security class and category of the MAC to thereby internally encrypt packets for use in network communications; minimizing deterioration in network performance by using the security class of the MAC; providing a trusted channel function by installing a kernel to which a trusted channel is applied.

In accordance with one aspect of the present invention, there is provided an apparatus for providing a trusted channel among secure operating systems (OSs) to which a mandatory access control (MAC) policy is applied, the apparatus comprising: on a data transmission side: a MAC module for providing MAC information of a user; a kernel memory for specifying host addresses to which the trusted channel is to be applied and providing an encryption key for encryption of a packet and an authentication key for generation of authentication data; and a trusted channel sub system for determining whether or not to apply the trusted channel, if data to be transmitted to IP layer is provided from the user, by using the MAC information from the MAC module and the host addresses to which a trusted channel is to be applied from the kernel memory; creating a trusted channel header if the application of the trusted channel is determined; encrypting. a specific portion of the packet; storing the authentication data in the trusted channel header; and transmitting the packet through a network; on a data reception side: a trusted channel sub system for investigating whether the trusted channel is applied; retrieving the authentication data in the trusted channel header; decrypting the packet if the authentication data is valid; conducting trusted channel header processings; and transferring the packet to an upper level by following a routine for delivering the packet to an input processing section of the upper level to thereby provide the packet to a user on the data reception side; and a kernel memory for providing an authentication key for the authentication of the packet and an encryption key for the decryption of the packet.

In accordance with another aspect of the present invention, there is provided a method for providing a trusted channel among secure operating systems (OSs) including a trusted channel sub system and a kernel memory on each of a data transmission side and a data reception side and a MAC module on the data transmission side, the method comprising the steps of: (a) executing a packet output routine of an Internet Protocol (IP) layer if data to be transmitted to the IP layer is provided from the user; and searching. the MAC module and the kernel memory on the data transmission side to determine whether or not to apply a trusted channel to a corresponding packet; (b) creating a trusted channel header for storing therein information generated at a time when the trusted channel is applied and security information, i.e., a class and a category, of the user if the application of the trusted channel is determined in the step (a); (c) encrypting all areas of the trusted channel header excluding an authentication data portion and an initial vector portion; generating authentication information for an integrity of the packet; and storing the authentication. information in the trusted channel header; (d) conducting a checksum processing and a fragmentation processing for the IP packet and providing the packet to the trusted channel sub system on the data reception side through a network by following a lower level output routine; (e) performing a reassembling processing and a checksum processing, at a reception side IP input processing unit, for the packet received at the trusted channel sub system on the data reception side through the network and investigating whether the trusted channel is applied to the packet by examining a next protocol field of an IP header in order to decrypt the packet; (f) retrieving the authentication data in the trusted channel header before decrypting the packet if it is found in the step (e) that the trusted channel is applied to the packet and decrypting the packet if the authentication data is valid while discarding the packet if the authentication data is not valid; and (g) transferring the decrypted packet to an upper level by following a routine for delivering the packet to an input processing section of an upper level to thereby provide the packet to a user on the data reception side.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of an apparatus for providing a trusted channel among secure operating systems using a mandatory access control (MAC) in accordance with the present invention;

FIGS. 2A and 2B provide flowcharts describing a method for providing a trusted channel among secure operating systems using a MAC in accordance with the present invention;

FIG. 3 describes a format of a trusted channel header for recording therein information generated by the application of a trusted channel and user information (class and category) in accordance with the present invention;

FIG. 4 shows an encryption area and an authentication area in a packet to which a trusted channel header is applied in accordance with the present invention; and

FIGS. 5A to 5F are drawings for describing communication environments in which trusted channels can be applied in accordance with the present invention.

### DETAILED DESCRIPTION OF PREFERRED EMBODIMENT

The preferred embodiments of the present invention will now be described with reference to the accompanying drawings.

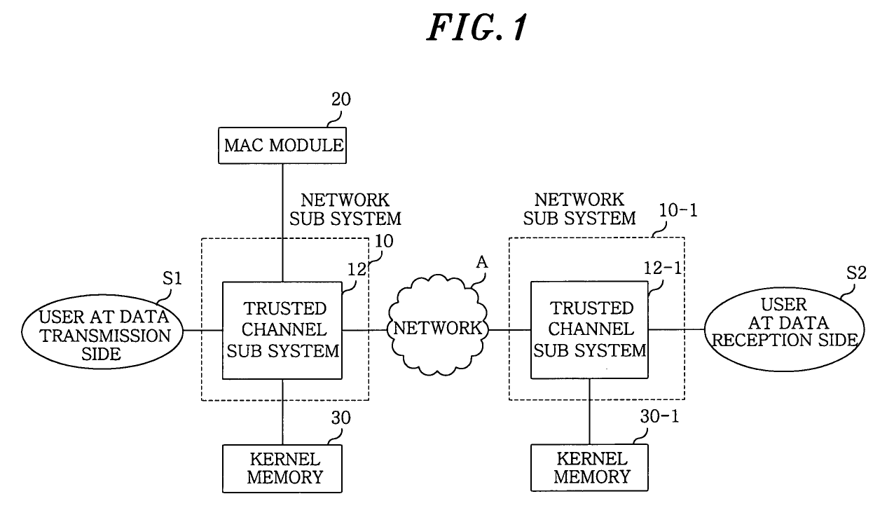

Referring to FIG. 1, there is provided a block diagram of an apparatus for providing a trusted channel among secure operating systems (OSs) employing a mandatory access control (MAC) policy. The apparatus includes network sub systems 10, 10-1, a MAC module 20 and kernel memories 30, 30-1.

Each of the network sub systems 10 and 10-1 performs a network function within a kernel. The network sub system 10 includes a trusted channel sub system 12 which takes charge of encryption of a packet while the network sub system 10-1 has a trusted channel sub system 12-1 that is in charge of decryption of an encrypted packet.

In data transmission processing, if communication request data is provided from a user S1 on a data transmission side, the trusted channel sub system 12 conducts an IP layer packet output routine in case the provided data corresponds to a packet transmission request. In other words, a packet output routine of an IP layer is executed if data to be transmitted to the IP layer is provided from the user. If the packet output processing is completed, the trusted channel sub system 12 searches the kernel memory 30 and the MAC module 20 in order to determine whether or not to apply a trusted channel to the packet, i.e., whether or not to encrypt the packet, before conducting a transmission of the packet.

In case a trusted channel is applied to the packet, the trusted channel sub system 12 creates a trusted channel header for storing therein information about the trusted channel. The trusted channel header includes an authentication data area for guaranteeing integrity of encrypted data, an initial vector area for decryption of the data, a next protocol area for a correct upper protocol processing, a header length area for identifying a length of the header, a padding length area for indicating a length of padding used for data encryption; and a MAC class and a MAC category area for delivering MAC information of a communication user. After a certain portion of the packet is encrypted, authentication information is generated for the integrity of the. packet and the generated authentication information is stored in the trusted channel header. In the data transmission processing, encryption of the packet is executed only if two requirements are satisfied: a destination address of the packet should correspond to an address of a host to which a trusted channel is applied and the user who requested the network communication should have a MAC security class. At this time, the address information of the host using the trusted channel is obtained from the kernel memory 30 while the MAC security class information is retrieved from the MAC module 20. The fact that the trusted channel is applied to the packet is expressed at a specific portion (hereinafter, referred to as a trusted channel application expression portion) of a header of the encrypted packet.

Subsequently, the trusted channel sub system 12 executes an IP packet output processing, i.e., a checksum processing and a fragmentation processing for the packet; and then transmits the packet through a network A by following a lower level output routine.

The MAC module 20 provides the MAC information of the user who requested the network communication and the MAC information is used for determining whether or not to apply the trusted channel to the packet. Further, if the trusted channel is applied, the MAC class and category information to be stored in the trusted channel header are also provided from the MAC module 20.

The kernel memory 30 provides host addresses to which the trusted channel is to be applied. Further, an encryption key and an authentication key used in case of adopting the trusted channel are also provided from the kernel memory 30.

When a packet is received through the network A, the trusted channel sub system 12-1 conducts a reassembling processing, a checksum processing and all other required processings for the packet before transmitting the packet to an upper level. Thereafter, the trusted channel sub system 12-1 determines whether a trusted channel is applied to the packet by investigating the trusted channel application expression portion of a header of the packet.

In case it is found that a trusted channel is applied to the packet, i.e., the packet is encrypted, the trusted channel sub system 12-1 retrieves authentication data in a trusted channel header before executing decryption of the packet and, if the authentication data is valid, decrypts the packet. In case the authentication data is found to be invalid, on the other hand, the packet is discarded.

After decrypting the corresponding packet, the trusted channel sub system 12-1 conducts trusted channel header processings, e.g., adjusting the length of the packet and specifying a protocol to be processed at the upper level, for the sake of a normal packet processing at an upper level. If the trusted channel header processing is completed, the trusted channel sub system 12-1 transfers the packet to the upper level by following a routine for delivering a packet from an IP input processing section to an input processing section of the upper level. If the upper level packet processing is finished, the trusted channel sub system 12-1 finally provides the packet to a user S2 on a datareception side.

The kernel memory 30-1 offers an: authentication key and an encryption key required for authentication and decryption of a received packet which is encrypted.

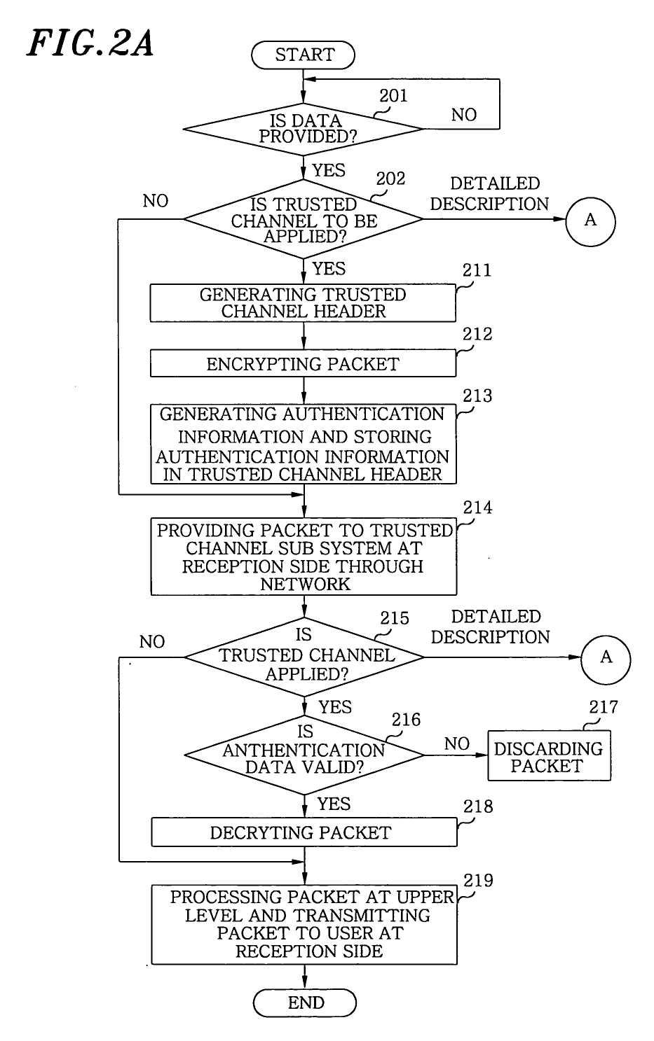

Referring. to FIG. 2, there is provided a flowchart describing a method for providing a trusted channel among secure OSs to which a MAC policy is applied in accordance with the present invention.

First, it is determined whether data according to a communication request is provided from a user S1 on a data transmission side (Step 201).

If no data is offered from the user S1, the step 201 is repeatedly performed.

If there is found data provided from the user S1 in the step 201, the trusted channel sub system 12 conducts a packet output routine of an IP layer if the provided data corresponds to a packet transmission request, i.e., data to be transmitted to the IP layer is provided; and searches the kernel memory 30 and the MAC. module 20 to determine whether a trusted channel, i.e., encryption, is to be applied to the packet (Step 202).

Specifically, in order to determine whether or not to apply a trusted channel to the packet in the step 202, it is checked whether a packet input or a packet output is involved (Step 203).

If a current operation is a packet input process, it is investigated whether a next protocol field of an IP header represents a trusted channel header (Step 204). If so, a trusted channel is applied to the packet (Step 205). However, if it is found in the step 204 that the next protocol field does not represent a trusted channel header, the application of a trusted channel is not executed (Step 206).

If the current operation is found to be a packet output process in the step 203, a destination address of the packet is investigated in order to check whether the destination address of the packet corresponds to an address of a host to which a trusted channel is to be applied (hereinafter, referred to as a trusted channel application host address) (Step 207). Trusted channel application host addresses are written in a file and loaded into the kernel memory 30 at a time when the system 12 is initialized.

In determining whether or not to apply a trusted channel to the corresponding packet in the packet transmission processing, the destination address of the packet is compared with the trusted channel application host addresses stored in the kernel memory 30. If the destination address of the packet corresponds to one of the trusted channel application host addresses, it is investigated whether a security class is assigned to the user S1 who requested the packet transmission (Step 208).

If it is found in the step 207 that the destination address of the packet is not one of the trusted channel application host addresses, application of a trusted channel is not executed (Step 210).

If the user S1 has a security class in the step 208 and the destination address of the packet is one of the trusted channel application host addresses, application of a trusted channel is conducted (Step 209). At a time of applying the trusted channel, the trusted channel header is recorded in the next protocol field of an IP header of the packet to be processed, whereby the data reception side can be informed of whether the trusted channel is applied to the packet. If the investigation result shows that the user S1 does not have a security class in the step 208, however, application of a trusted channel is not executed (Step 210).

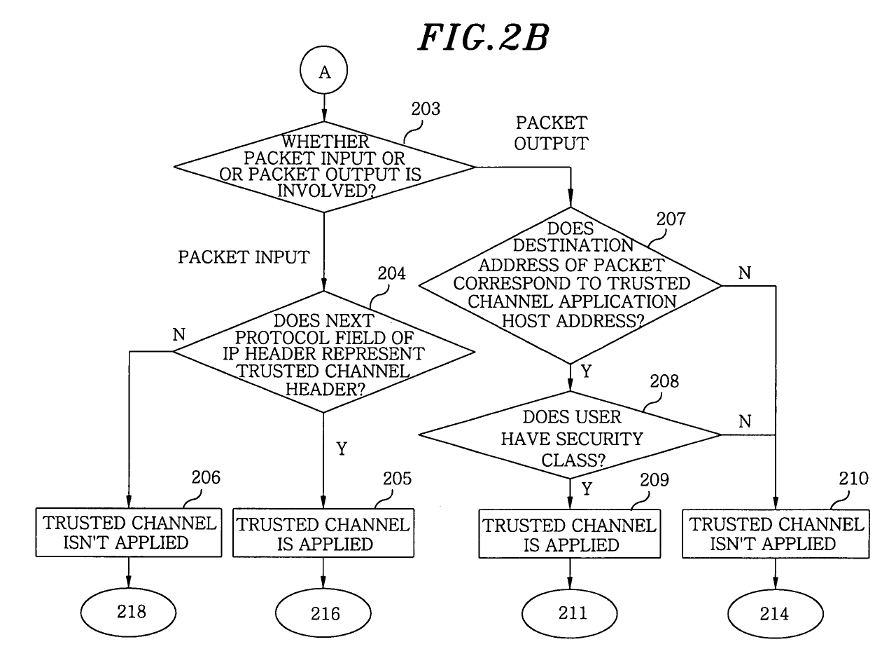

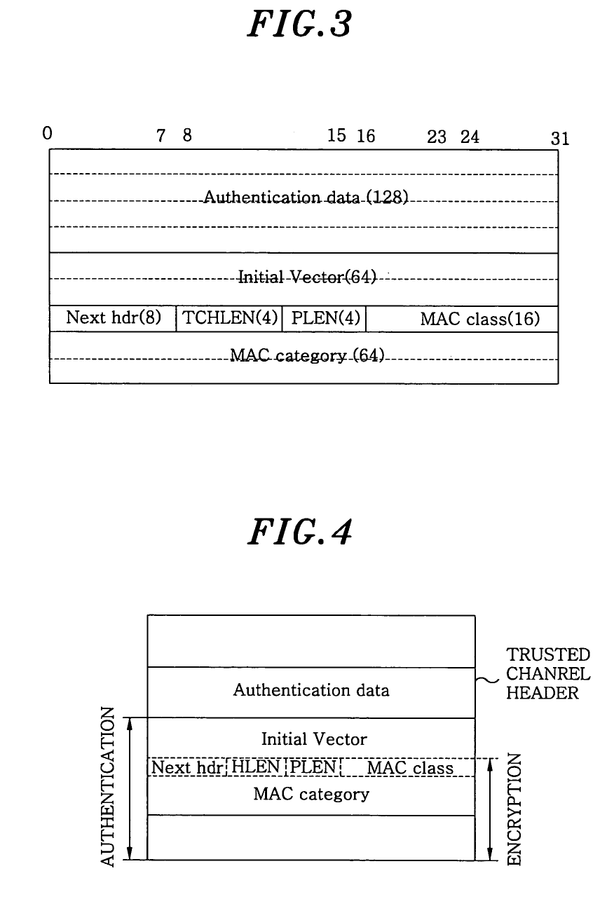

In case application of a trusted channel is determined in the step 202, the trusted channel sub system 12 creates a trusted channel header as shown in FIG. 3 for storing information generated by the application of the trusted channel and security information (class and category) of the user (Step 211).

The trusted channel header has a simple format compared to a header employed in IPSec due to the characteristics of environment providing a trusted channel. Since employed with the MAC policy, the trusted channel header has a structure capable of enabling transmission of security information of a network communication user. In a preferred embodiment of the present invention, the trusted channel header has a length of about 36 bytes (288 bits) FIG. 3 shows an architecture of the trusted channel header, which includes a 128-bit Authentication data field containing authentication information for encrypted data, a 64-bit Initial Vector field used as encryption synchronization data of an encryption algorithm, a 8-bit Next header field identifying an upper level protocol of a current IP, a 4-bit TCHLEN field indicating a length in bytes of the trusted channel header, a 4-bit PLEN field designating a length in bytes of a padding used for encryption, and a 16-bit MAC class field and a 64-bit MAC category field showing MAC information of the user who requested the communication. The length of an initial vector may be varied depending on an encryption unit of the encryption algorithm.

Referring to FIG. 4, there is provided a drawing showing an encryption area and an authentication area of a packet to which the trusted channel header is applied. The trusted channel header is located next to an IP header. The fields of the trusted channel header excluding the authentication data field and the initial vector field are all encrypted (Step 212). Then, authentication information is generated for the integrity of the packet and stored in the trusted channel header (Step 213).

Subsequently, the trusted channel sub system 12 executes an IP packet output processing, i.e., a checksum processing and a fragmentation processing for the packet and, then, provides the packet to the trusted channel sub system 12-1 through the network A by following a lower level output routine (Step 214).

Referring back to the step 202, if it is determined that application of a trusted channel is not performed, the step 214 is immediately executed.

The trusted channel sub system 12-1 performs a reassembling processing, a checksum processing and all other required processings for the received packet before the packet is transferred to an upper level. Thereafter, it is determined whether the trusted channel header has been applied to the packet by examining a trusted channel application field of the packet header before the packet is delivered to an input processing unit of the upper level (Step 215).

If it is found in the step 215 that a trusted channel has been applied to the packet, i.e. if the packet is encrypted, the authentication data of the trusted channel header is examined before decrypting the packet (Step 216).

If the authentication data is valid in the step 216, the decryption of the packet is conducted (Step 218). If the authentication data is invalid, however, the packet is deserted (Step 217).

Referring back to the step 215, if a trusted channel has not been applied to the packet, i.e., if the packet is not encrypted, the packet is immediately transferred to the upper level to enable a normal network processing (Step 219).

After decrypting the corresponding packet, the trusted channel sub system 12-1 conducts trusted channel header processings, e.g., adjusting the length of the packet and specifying a protocol to be processed at the upper level, for the sake of a normal packet processing at the upper level. If the trusted channel header processing is completed, the trusted channel sub system 12-1 transfers the packet to the upper level by following a routine for delivering a packet from an IP input processing section to an input processing section of the upper level. Thereafter, the trusted channel sub system 12-1 finally provides the packet to the user S2 on the data reception side.

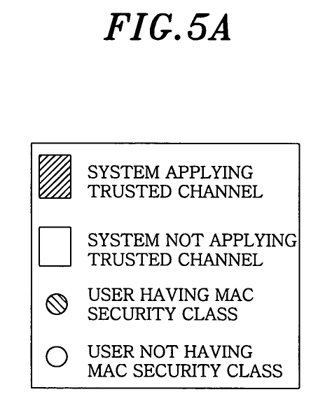

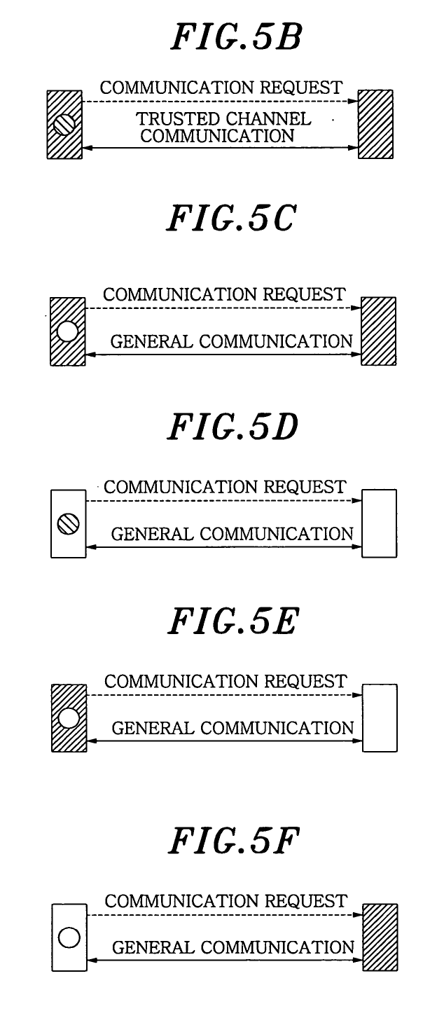

FIGS. 5A to 5F illustrate environments for applying trusted channels.

FIG. 5A defines meanings of symbols used through FIGS. 5B to 5F. FIG. 5B shows environment where a trusted channel is applied to thereby allow safe trusted channel communication. In such environment, if a user having a security class within a system to which a trusted channel is applied requests communication with another system to which a trusted channel is also applied, packets are automatically encrypted before transmitted and the encrypted packets received at a counterpart system are automatically decrypted.

FIG. 5C describes a case where communication is maintained between systems to which trusted channels are applied. In FIG. 5C, however, the user who requests the communication does not have a security class. FIG. 5D describes a case where a user having a security class within a system using a trusted channel communicates with a general system (meaning a system not using a trusted channel). FIG. 5E illustrates an environment where a general user (meaning a user not having a security class) within a system using a trusted channel communicates with a general systems and FIG. 5F shows an environment in which a general user in a general system communicates with a system using a trusted channel. Accordingly, trusted channels are not applied in communication environments of FIGS. 5C to 5F.

Such a trusted channel application policy as described above allows for co-use of a system adopting a trusted channel and a system not using the trusted channel. Further, by allowing packet encryption only for a user having a security class, security information of the user can be protected and deterioration of network performance that may be caused by excessive encryption processings can be reduced.

The present invention as described above provides a new header for internally encrypting a packet for use in network communications by using a MAC security class. By using the MAC security class, deterioration in network performance can be minimized. Further, by applying a trusted channel to the packet, the contents of data can be prevented from being exposed even in case the packet is intercepted while being transmitted since the packet is encrypted. Furthermore, even though the contents of the data packet are replaced with malicious contents, such modulation of data can be detected by examining the integrity of the packet through the use of authentication data. In addition, the present invention enables to protect packets transferred from a user through a network without the need of additional extra network security function. By employing a simple policy, deterioration of system performance due to packet protection can be reduced. Moreover, since the present invention is operated on a security kernel using a MAC, the operation of the present invention becomes possible just by installing a simple patch or a kernel to which a trusted channel is applied. Further, a setting process is completed just by specifying the addresses of hosts to which trusted channels are to be applied. Furthermore, since the employed policy is simple, the size of the new header is not large but just about 36 bytes. Still further, it is possible to manage security information of a user at a remote host. Furthermore, since operated within a kernel by using its own header, the present invention can be employed to work with an IPSec function. Moreover, performance deterioration can be minimized since whether or not to apply a trusted channel is determined just by considering a destination address of a corresponding packet and a security class of a user.

While the present invention has been shown and described with respect to the preferred embodiments, it will be understood by those skilled in the art that various changes and modifications may be made without departing from the spirit and scope of the invention as defined in the following claims.

What is claimed is:

1. An apparatus for providing a trusted channel among secure operating systems (OSs) to which a mandatory access control (MAC) policy is applied, the apparatus comprising:
on a data transmission side:
a MAC module for providing MAC information of a user;
a kernel memory for specifying host addresses to which the trusted channel is to be applied and providing an encryption key for encryption of a packet and an authentication key for generation of authentication data; and
a trusted channel sub system for determining whether or not to apply the trusted channel, if data to be transmitted to IP layer is provided from the user, by using the MAC information from the MAC module and the host addresses to which a trusted channel is to be applied from the kernel memory; creating a trusted channel header if the application of the trusted channel is determined; encrypting a specific portion of the packet; storing the authentication data in the trusted channel header; and transmitting the packet through a network;
on a data reception side:
a trusted channel sub system for investigating whether the trusted channel is applied; retrieving the authentication data in the trusted channel header; decrypting the packet if the authentication data is valid; conducting trusted channel header processings; and transferring the packet to an upper level by following a routine for delivering the packet to an input processing section of the upper level to thereby provide the packet to a user on the data reception side; and
a kernel memory for providing an authentication key for the authentication of the packet and an encryption key for the decryption of the packet.

2. The apparatus of claim 1, wherein the application of the trusted channel is determined in case of data transmission, if two requirements are satisfied: a destination address of the packet should correspond to one of the host addresses to which the trusted channel is applied and the user should have a MAC security class and if the application of the trusted channel is determined, the application of the trusted channel is indicated in a next protocol field of an IP header of the packet.

3. The apparatus of claim 2, wherein the application of the trusted channel is investigated, in case of data reception, by checking whether the next protocol field of the IP header of the packet represents the trusted channel header.

4. The apparatus of claim 1, wherein the trusted channel header includes an authentication data area for guaranteeing an integrity of the encrypted data, an initial vector area for the decryption of the encrypted data, a next protocol area for a correct upper protocol processing, a header length area for identifying a length of the header, a padding length area for indicating a length of padding used for data encryption; and a MAC class and a MAC category area for delivering the MAC information of the user.

5. The apparatus of claim 4, wherein encryption area of the packet for maintaining security of the packet is set to be all areas thereof excluding an IP header area, the authentication data area and the initial vector area.

6. A method for providing a trusted channel among secure operating systems (OSs) including a trusted channel sub system and a kernel memory on each of a data transmission side and a data reception side and a MAC module on the data transmission side, the method comprising the steps of:
(a) executing a packet output routine of an Internet Protocol (IP) layer if data to be transmitted to the IP layer is provided from the user; and searching the MAC module and the kernel memory on the data transmission side to determine whether or not to apply a trusted channel to a corresponding packet;
(b) creating a trusted channel header for storing therein information generated at a time when the trusted channel is applied and security information, i.e., a class and a category, of the user if the application of the trusted channel is determined in the step (a);
(c) encrypting all areas of the trusted channel header excluding an authentication data portion and an initial vector portion; generating authentication information for an integrity of the packet;. and storing the authentication information in the trusted channel header;
(d) conducting a checksum processing and a fragmentation processing for the IP packet and providing the packet to the trusted channel sub system on the data reception side through a network by following a lower level output routine;
(e) performing a reassembling processing and a checksum processing, at a reception side IP input processing unit, for the packet received at the trusted channel sub system on the data reception side through the network and investigating whether the trusted channel is applied to the packet by examining a next protocol field of an IP header in order to decrypt the packet;
(f) retrieving the authentication data in the trusted channel header before decrypting the packet if it is found in the step (e) that the trusted channel is applied to the packet and decrypting the packet if the authentication data is valid while discarding the packet if the authentication data is not valid; and
(g) transferring the decrypted packet to an upper level by following a routine for delivering the packet to an input processing section of an upper level to thereby provide the packet to a user on the data reception side.

7. The method of claim 6, wherein the application of the trusted channel is determined in the step (a) by examining a destination address of the packet corresponds to one of the host addresses to which the trusted channel is applied and the user has a MAC security class.

8. The method of claim 6, wherein the trusted channel header is recorded in the next protocol field of an IP header of the packet to inform the user on the data reception side of the fact that the trusted channel is applied to the packet.

9. The method of claim 6, wherein the trusted channel header includes a 128-bit authentication data field containing the authentication information for the encrypted packet., a 64-bit initial vector field used as encryption synchronization data of an encryption algorithm, a 8-bit next header field identifying an upper level protocol of IP, a 4-bit trusted channel header length field indicating a length in bytes of the trusted channel header, a 4-bit padding length field designating a length in bytes of a padding used for the encryption of the packet, and a 16-bit MAC class field and a 64-bit MAC category field showing MAC information of the user who requests the communication.
